(19) United States
(12) Patent Application Publication
(10) Pub. No.: US 2003/0200245 A1
(43) Pub. Date: Oct. 23, 2003

(54) Multiplier for non-integral multiplicators

(76) Inventor: Hung-Ming Chien, Taipei (TW)

Correspondence Address: RABIN & BERDO, P.C., Suite 500, 1101 14th Street, N.W., Washington, DC, 20005, US

(21) Appl. No.: 10/458,258

(22) Filed: Jun. 11, 2003

Related U.S. Application Data
(63) Continuation-in-part of application No. 09/562,906, filed on May 2, 2000.

(51) Int. Cl. G06F 7/38

(52) U.S. Cl. 708/523

(57) ABSTRACT

The present invention provides a kind of multiplier for non-integral multiplicators, which uses approximation method to carry out multiplication of non-integral values. Based on the approximation method comes out a new structure of fixed-point calculation multiplier, which is suitable for integrated circuit design and can be used in pipe line operation. The precision can be modified according to the actual requirements. Composed of n−1 displacement adder-subtractors and one displacement carrier in tandem, the multiplier is an n-grade multiplier. When a higher precision is required, more displacement adders can be concatenated at the end of the multiplier. Therefore, the number of displacement adders can be increased or reduced according to the design requirements, so as to reach the balance between precision and number of logic gates.

### RELATED APPLICATION

This application is a Continuation-In-Part of U.S. patent application Ser. No. 09/562,906, filed May 2, 2000.

### FIELD OF THE INVENTION

The present invention relates to a kind of multiplier for non-integral multiplicators, which uses approximation method to execute multiplication of non-integral values. Based on the approximation method comes out a new structure of fixed-point calculation multiplier, which is suitable for integrated circuit design and allows reducing the number of logic gates required by the multiplier, thus making the multiplier more suitable for pipe line operation. The precision can be modified according to the actual requirements, so as to enable the number of logic gates required by the multiplier after modification to meet different design requirements.

### BACKGROUND OF THE INVENTION

A lot of applications referring to digital signal processing require calculation of non-integral multiplication, such as matrix vector multiplication in color space conversion (CSC) and discrete cosine transformation (DCT). Application of CSC is often seen in conversion between different color standards (for instance, NTSC, PAL, CCIR601, SECAM and other color vector representation standards), while DCT is often applied in different standards of image compression (JPEG, MPEG, H263, etc.)

Non-integral multiplication is usually seen in specific matrix-vector multiplication. For example, in DCT calculation, which is applied in many image compression standards, multiplication of 8×8 conversion matrix vs. 8×1 vector. While the conversion of color space is multiplication of 3×3 color conversion matrix vs. 3×1 color vector. The above is two examples of conversion matrix vs. vector multiplication. In this kind of calculations, matrix's elements are all specified non-integral values, while the vector is an unspecified value. Therefore, the multiplication in this kind of calculation is called multiplication with some specified multipliers.

Usually there are two ways to accomplish the multiplication with some specified multipliers. One is to use general-purpose multiplier. The so-called general-purpose multiplier means the two multiplication factors are both unspecified, and so the specified multipliers need to be stored in temporary memory for usage in need. In integrated circuits, general-purpose multiplier requires a huge number of logic gates, and when the bits number of multiplicator or multiplicand is increased, the number of logic gates required by the multiplier will grow in a multiple (series logic multiplier) or exponential way (compound logic multiplier). Although general-purpose multiplier can provide correct calculation results, it still has lots of errors in the above-mentioned DCT or CSC applications. This is because using finite bits to express non-integral values will cause quantization error. In order to reduce the error, the number of bits representing non-integrate value must be increased. So, general-purpose multiplier will occupy too many resources, and it is not economical. Suppose n bits are used to express a positive decimal fraction less than 1, an error root mean square of −3n dB (10·log₁₀[2⁻ⁿ]) will occur.

The other way is to use look-up table method to accomplish multiplication with specified multipliers. In most applications of specific matrix-vector multiplication, the number of multiplicators (i.e., elements in the conversion matrix) is not too big, and the input multiplicands are also limited in a certain range. Therefore, it is possible to deduce all or part of possible results in advance, and store them in the read-only memory (ROM). During calculation, the correct result can be checked out from the table according to the input multiplicand and multiplicator. Or use the adder to make combination based on the partial result from the table to get the correct result. Usually, among the calculation results with the same input bits number, the result got by look-up table method has the lowest error. However, it also cost much. That is, it requires lots of ROM spaces. Generally speaking, the space of ROM is exponentially proportional to the bits number of the multiplicand, while is proportional to the bits number of output result and the number of specified multiplicators. For an example of multiplier using ROM and accumulator, suppose the input multiplicand has X bits, the number of specified multiplicator is Y, and the output result has Z bits, then the space of ROM required by look-up table method is ROM=2·2^{X/2}·Y·Z. For example, if the multiplicand has 8 bits, the number of multiplicator is 8, and the bits number of output result is 16, then the required ROM space is 4*10³ Bit. Therefore, calculation using look-up table method also costs lots of resources.

The present invention provides a multiplier for non-integral multiplicators, which can be used in applications of non-integral multiplication, and employ a new method to reduce the resource consumption. Although it uses the approximation method to accomplish multiplication of non-integral values, the error can be controlled in the permissible range. Therefore, it can provide a more beneficial choice in some occasions.

### SUMMARY OF THE INVENTION

The purpose of the present invention is to provide a kind of multiplier for non-integral multiplicators, which uses adder and shifter in cascade to accomplish multiplication. The design can be modified according to the required precision. When a higher precision is required, more shifter-adders can be concatenated at the end of the multiplier. Therefore, the number of shifter-adders can be increased or reduced according to the design requirements, so as to reach the balance between precision and number of logic gates.

As shown above, the multiplier put the coefficients input by the addition displacer at each grade into an proper time sequence, thus forming a pipe-line structure. The multiplier can accept a new multiplicand at each clock pulse. And after a delay of n clock pulses, each clock pulse will get a corresponding output. When use the approximation method to find the best multiplier parameter combination for the multiplicator, selection of a proper approximate value can simplify the synthetic logic line and reduce the time delay on the line, and the maximum range of approximate values enables the multiplier to have more combinations under the same number n of grades and to get more accurate results.

In order to make the characteristics of the present invention understood better, detailed description on the structure design and working principle of the invention is given hereinafter matched with the figures.

### BRIEF DESCRIPTION OF THE DRAWINGS

Drawings:

FIG. 1 is the diagrammatic sketch of the general-purpose structure of the multiplier provided by the present invention.

FIG. 2 is the diagrammatic sketch of the pipeline structure of three-grade multiplier with fixed coefficients.

FIG. 3 is the clock pulse table of FIG. 2.

Code numbers:

| | |
|---|---|
| 10 | Multiplier |
| 21 | Adder |
| 22 | Shifter |
| 20 | Shifter-adder |
| 30 | Coefficient Table |

### DETAILED DESCRIPTION OF THE INVENTION

Before to explain the structure of the multiplier brought forward in the present invention, let's at first explain the expression of multiplicators used in this invention. The expression employs a kind of value approximation method to transform a value into a continuous multiplication equation as shown below:

a=(1±2^{-r1})(1±2^{-r2})(1±2^{-r3}) . . . (1±2^{-rn-1})·2^{-rn} (1)

The equation above is the approximation of n terms. The more terms are used, the more accurate the approximation is. The symbol “±” in each term means either addition or subtraction, which is determined by each value. The exponent of “2” in

| | | | |
|---|---|---|---|
| cos3π/8 | 0.3827 | 40.3 db | [1, 1, 3], [1, 1, 3], [1, 1, 11], [0, 1, 12], [1] |

In the table above, the relative error is calculated using the formulation below:

$$10 \cdot {log}_{10} [ \frac{True value - Approximate value }{True value} ] \qquad ( 3 )$$

The approximation method used in Equation (2) can't directly deduce the relation between the error and the number of grades “n”. Therefore, the table below shows the maximum relative error and error root mean square supposing the possible multiplicators are not more than 1, maximum shifting not more than 12 (rₖ≦12). (Under the consideration that Error<−30 dB and logical gate count<2000)

TABLE 2

| | Maximum relative error | Error mean root square |
|---|---|---|
| n = 2 | −10.8 dB | −16.9 dB |
| n = 3 | −15.6 dB | −24.6 dB |
| n = 4 | −22.8 dB | −34.0 dB |
| n = 5 | −29.8 dB | −43.2 dB |

The values in table 2 are just some statistic results; therefore, the number of grades (n) must be selected according to the actual circumstance.

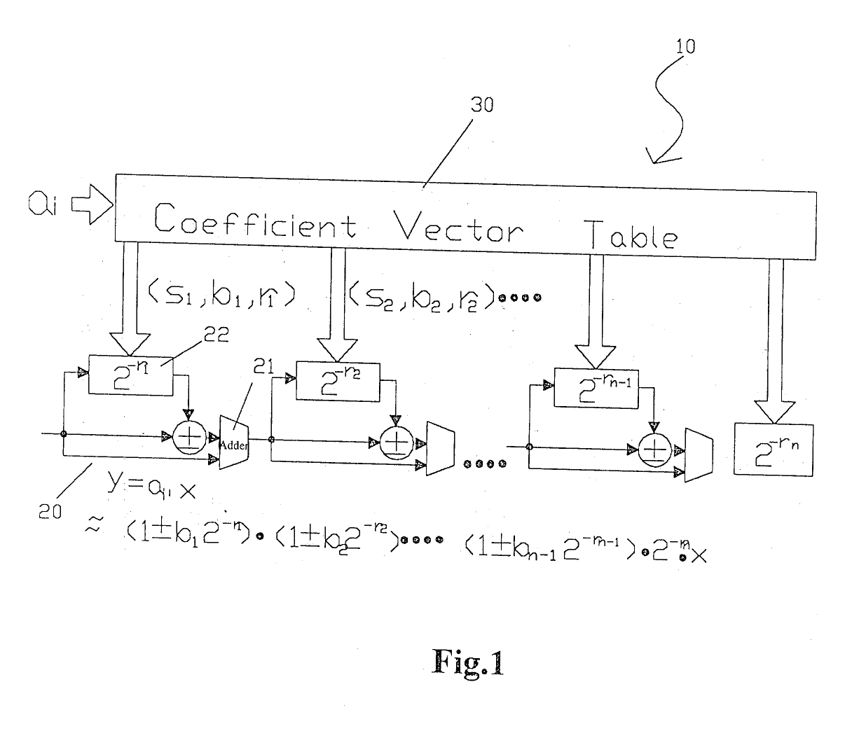

The structure of the multiplier (10) for non-integral multiplicators in the present invention is as shown in FIG. 1. The multiplier uses shifter-adders (20) comprising adders (21) and shifter (22). The design can be modified according to the actual requirements. When a higher precision is required, more shifter-adders (20) can be concatenated at the end of the multiplier. Therefore, the number of shifter-adders (20) can be increased or reduced according to the design requirements, so as to reach the balance between precision and number of logic gates.

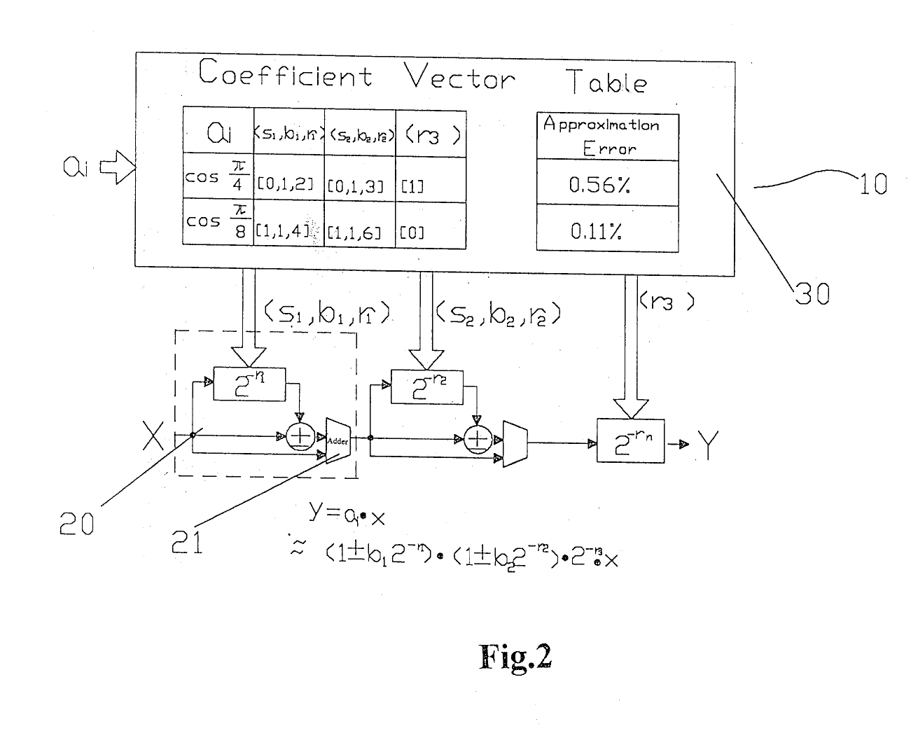

Appropriately arrange the coefficient input by the shifter-adder at each stage into a time sequence, and we will get the pipeline structure of the present invention. Now, let's give an example of three-grade shifter-adders. FIG. 2 shows the structure of a three-grade multiplier for fixed coefficients. This multiplier (20), composed of 16-bit adders (21), performs pipe line operation to accomplish multiplication. Wherein the parameter combination table (30) of the optimal approximate value corresponding to each multiplicator is worked out in advance, and is stored in ROM. When a specified multiplicator is required, the corresponding parameter combination will be got from the ROM table. When composing logic lines, the size of the table shall also be considered much. But in the present invention, the size of the table (30) is relative to the number of grades (n) and the number of multiplicators. Suppose the number of multiplicators is a and rₖ is less than 12, then the table size required by n-grade multiplicator (10) is as follows:

Ta=MN·[6(n−1)+4] (4)

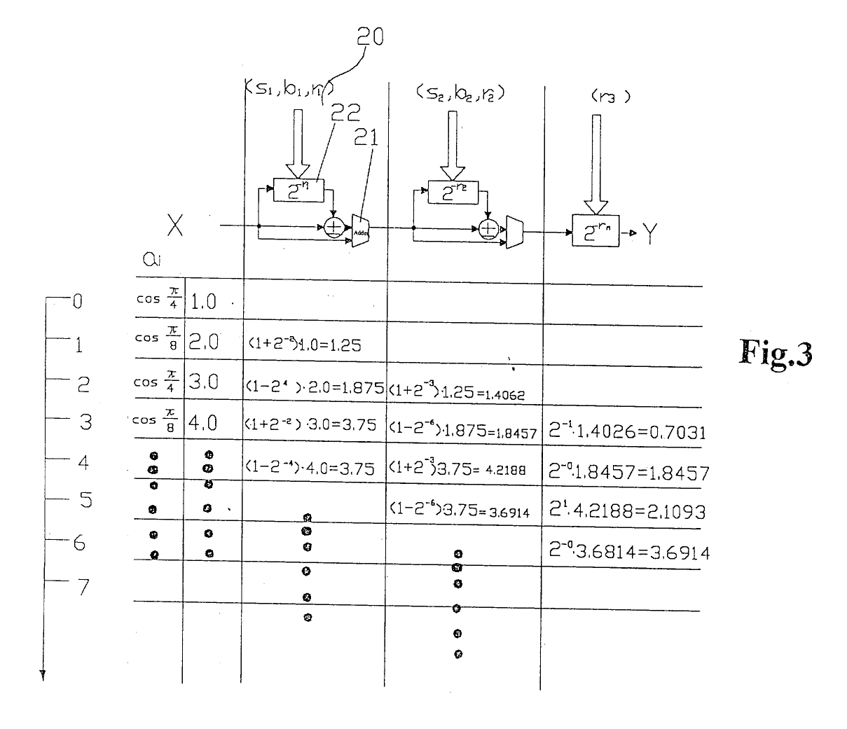

FIG. 3 shows the time sequence table stored in the temporary memory at each grade of the multiplicator (10) under pipe line operation. The multiplicator (10) can accept a new multiplicand at each clock pulse, and a corresponding output can be generated for each clock pulse after a time delay of n clock pulses. The width of each clock pulse (its reciprocal is the maximum operating frequency of the multiplier) is limited by the maximum path delay of the shifter and adder at each stage. Suppose the delay of adder (21) is a fixed value, so the width of clock pulse depends on the maximum delay of shifter (22). While the maximum possible delay of shifter (22) comes of the range of rₖ. A larger range of rₖ will result in a longer maximum path delay of shifter (22), and make the logic lines of shifter (22) be more Equation (2), number of grades n=4, the range of rₖ is 8, and the optimal parameter combination is {[0, 1, 3], [0, 1, 5], [1, 1, 8], [1]}. The range of possible input multiplicand is as follows. The results are of 16 bits. Then let us to compare the errors using the shifter-adder in different sequences {[0, 1, 3], [0, 1, 5], [1, 1, 8], [1]} and {[1, 1, 8], [0, 1, 3], [0, 1, 5], [1]}. See table 3.

TABLE 3
Approximate relative error: −31.0 dB

| | Maximum relative error | MSE |
|---|---|---|
| [1, 1, 8] in front | −22.7 dB | −30.4 dB |
| [1, 1, 8] behind | −28.7 dB | −30.4 dB |

From the table above we can know that, ranking the shifter-adder with larger displacement number behind can have more accurate results. The MSE of 8*8 GPM (16-bit output) is −31.1 dB. The error between the two is very approximate.

From the above description it can be well understood that the multiplier (10) introduced in the present invention can replace general-purpose multiplier in some occasions, and requires fewer logic gates.

Hereinafter several examples are given to make further explanation:

### EXAMPLE 1

before to use pipe line operation structure to establish the multiplier (10), it is necessary to determine the grades number of the multiplier (10) and the upper limit of the maximum shifting of the shifter-adder (20), so as to work out all the possible multiplicators, and select the required multiplicators to set up the coefficient table (30).

Suppose the maximum possible rightward shifting of the shifter-adder at each stage is 3, then the multiplicators that this grade can represent are:

(1−2⁻¹), (1−2⁻²), (1−2⁻³), 1, (1+2⁻³), (1+2⁻²), (1+2⁻¹)

=0.5, 0.75, 0.875, 1, 1.125, 1.25, 1.5

Connect two shifter-adders (20) in series and make continuous multiplication, then we will have 7×7=49 kinds of results. Get rid of the symmetry numbers, then we still have 25 kinds of different results (see table 4).

TABLE 4

| | 1 − 2⁻¹ | 1 − 2⁻² | 1 − 2⁻³ | 1 | 1 + 2⁻³ | 1 + 2⁻² | 1 + 2⁻¹ |
|---|---|---|---|---|---|---|---|
| 1 − 2⁻¹ | 0.2500 | 0.3750 | 0.4375 | 0.5000 | 0.5625 | 0.6250 | 0.7500 |
| 1 − 2⁻² | 0.3750 | 0.5625 | 0.6562 | 0.7500 | 0.8438 | 0.9375 | 1.1250 |
| 1 − 2⁻³ | 0.4375 | 0.6562 | 0.7656 | 0.8750 | 0.9844 | 1.0938 | 1.3125 |
| 1 | 0.5000 | 0.7500 | 0.87500 | 1.0000 | 1.1250 | 1.2500 | 1.5000 |
| 1 + 2⁻³ | 0.5625 | 0.8438 | 0.9844 | 1.1250 | 1.2656 | 1.4062 | 1.6875 |
| 1 + 2⁻² | 0.6250 | 0.9375 | 1.0938 | 1.2500 | 1.4062 | 1.5625 | 1.8750 |
| 1 + 2⁻¹ | 0.7500 | 1.1250 | 1.3125 | 1.5000 | 1.6878 | 1.8750 | 2.2500 |

Put the above results into another shifter-adder (20) again (as said above, the maximum shifting is 3), then more combinations will come out. All the results are shown in table 5. Table 5

TABLE 5

| | | (s₁,r₁) | | | | | | |
|---|---|---|---|---|---|---|---|---|
| | | (1, 1) | (1, 2) | (1, 3) | (0, 0) | (0, 3) | (0, 2) | (0, 1) |
| (s₂, r₂) | | | | | | | | |
| r₃ = 0 | (1, 1) | 0.2500 | 0.3750 | 0.4375 | 0.5000 | 0.5625 | 0.6250 | 0.7500 |
| | (1, 2) | 0.3750 | 0.5625 | 0.6562 | 0.7500 | 0.8438 | 0.9375 | 1.1250 |
| | (1, 3) | 0.4375 | 0.6562 | 0.7656 | 0.8750 | 0.9844 | 1.0938 | 1.3125 |
| | (0, 0) | 0.5000 | 0.7500 | 0.8750 | 1.0000 | 1.1250 | 1.2500 | 1.5000 |
| | (0, 3) | 0.5625 | 0.8438 | 0.9844 | 1.1250 | 1.2656 | 1.4062 | 1.6875 |
| | (0, 2) | 0.6250 | 0.9375 | 1.0938 | 1.2500 | 1.4062 | 1.5625 | 1.8750 |
| | (0, 1) | 0.7500 | 1.1250 | 1.3125 | 1.5000 | 1.6875 | 1.8750 | 2.2500 |
| r₃ = 1 | (1, 1) | 0.1250 | 0.1875 | 0.2188 | 0.2500 | 0.2812 | 0.3125 | 0.3750 |
| | (1, 2) | 0.1875 | 0.2812 | 0.3281 | 0.3750 | 0.4219 | 0.4688 | 0.5625 |
| | (1, 3) | 0.2188 | 0.3281 | 0.3828 | 0.4375 | 0.4922 | 0.5469 | 0.6562 |
| | (0, 0) | 0.2500 | 0.3750 | 0.4375 | 0.5000 | 0.5625 | 0.6250 | 0.7500 |
| | (0, 3) | 0.2812 | 0.4219 | 0.4922 | 0.5625 | 0.6328 | 0.7031 | 0.8438 |
| | (0, 2) | 0.3125 | 0.4688 | 0.5469 | 0.6250 | 0.7031 | 0.7812 | 0.9375 |
| | (0, 1) | 0.3750 | 0.5625 | 0.6562 | 0.7500 | 0.8438 | 0.9375 | 1.1250 |
| r₃ = 2 | (1, 1) | 0.0625 | 0.0938 | 0.1094 | 0.1250 | 0.1406 | 0.1562 | 0.1875 |
| | (1, 2) | 0.0938 | 0.1406 | 0.1641 | 0.1875 | 0.2109 | 0.2344 | 0.2812 |
| | (1, 3) | 0.1094 | 0.1641 | 0.1914 | 0.2188 | 0.2461 | 0.2734 | 0.3281 |
| | (0, 0) | 0.1250 | 031875 | 0.2188 | 0.2500 | 0.2812 | 0.3125 | 0.3750 |
| | (0, 3) | 0.1406 | 0.2109 | 0.2461 | 0.2812 | 0.3164 | 0.3516 | 0.4219 |
| | (0, 2) | 0.1562 | 0.2344 | 0.2734 | 0.3125 | 0.3516 | 0.3906 | 0.4688 |
| | (0, 1) | 0.1875 | 0.2812 | 0.3281 | 0.3750 | 0.4219 | 0.4688 | 0.5625 |
| r₃ = 3 | (1, 1) | 0.0312 | 0.0469 | 0.0547 | 0.0625 | 0.0703 | 0.0781 | 0.0938 |
| | (1, 2) | 0.0469 | 0.0703 | 0.0820 | 0.0938 | 0.1055 | 0.1172 | 0.1406 |
| | (1, 3) | 0.0547 | 0.0820 | 0.0957 | 0.1094 | 0.1230 | 0.1367 | 0.1641 |
| | (0, 0) | 0.0625 | 0.0938 | 0.1094 | 0.1250 | 0.1406 | 0.1562 | 0.1875 |
| | (0, 3) | 0.0703 | 0.1055 | 0.1230 | 0.1406 | 0.1582 | 0.1758 | 0.2109 |
| | (0, 2) | 0.0781 | 0.1172 | 0.1367 | 0.1562 | 0.1758 | 0.1953 | 0.2344 |
| | (0, 1) | 0.0938 | 0.1406 | 0.1641 | 0.1875 | 0.2109 | 0.2344 | 0.2812 |

Table 5 shows all the possible multiplicator values of the three-grade multiplier of the present invention. These values vary between 0.0312 and 2.25. From them a proper value can be selected as the approximate value of a multiplicator. For example, to select an approximate value to replace cos(≈0.7071), the approximate value 0.7031 of {(s₁, r₁), (S₂, r₂), r₃}={(0, 2), (0, 3), 1} in table 5 can be used; the error is 0.56%. If a higher precision is required, the following two methods can be used:

1. Add the grades number of the multiplier (10)

2. Increase the maximum possible rightward shifting of each shifter-adder (20), and establish a larger approximation table (30) so as to provide more approximate values for making choices.

The following is an example of pipe line operation:

Suppose the input value is x, and work out the result of multiplying x by cos(π/4) or cos(π/8). That is,

y=ax

a=cos(π/4) or cos(π/8)

Use the three-grade multiplier, and set the maximum possible rightward shifting is 8, then the non-integral values cos(π/4) and cos(π/8) can be expressed as follows:

cos(π/4)≈(1+2⁻²)×(1+2⁻³)×1=0.7031

Coefficient={(0, 2), (0, 3), 1}

cos(π/8)×(1−2⁻⁴)×(1−2⁻⁶)×1=0.9228

Coefficient={(1, 4), (1, 6), 0}

The true values of cos(π/4) and cos(π/8) are about 0.7071 and 0.9239; therefore, the errors are separately 0.56% and 0.11%. As shown in FIG. 3, suppose the x values input from zero time point are respectively 1, 2, 3 . . . , the corresponding multiplicators are cos(π/4), cos(π/8), cos(π/4), cos(π/8) . . . (See the left two lines in FIG. 3). FIG. 3 shows the values of temporary memories at each time point. After the set time delay, the correct output comes out.

Time point 0: ai=cos(π/4), x=1.0;

Time point 1: enter the first grade shifter-adder, and we get (1+2⁻²)×1=1.25;

Time point 2: enter the result of the previous grade into the next adder, and we get (1+2⁻³)×1.25=1.4062

Time point 3: enter the last shifter-adder, and we get 2−1×1.4062=0.7031

By doing so, we can get the result of multiplication with cos(?).

### EXAMPLE 2

### Color Space Conversion (CSC)

NISC standard uses Y, I and Q as the vectors of color space, wherein Y standards for brightness, I and Q stand for color signals. The relation of Y, I and Q with three original colors RGB (Red, Green, Blue) is as follows:

R=Y+0.956I+0.620Q

G=Y−0.272I−0.647Q

B=Y−1.108I−1.705Q

In order to work out R, G and B, we can use the multiplier (10) provided by the present invention to accomplish the multiplication with the multiplicators {0.956, 0.620, 0.272, 0.647, 1.108, 1.705}. Suppose the grades number of the multiplier (10) is 4 and the maximum possible rightward shifting is 8, then we will get the optimal coefficients in Table 6.

TABLE 6

| True value | Approximate value | Error | Coefficient |
|---|---|---|---|
| 0.9557 | 0.9559 | 0.02% | (0, 8) (0, 6) (1, 4), 0 |
| 0.6199 | 0.6200 | 0.02% | (0, 7) (0, 2) (1, 6), 1 |
| 0.2716 | 0.2718 | 0.07% | (0, 5) (0, 4) (1, 7), 2 |
| 0.6469 | 0.6470 | 0.02% | (0, 8) (0, 5) (0, 2), 1 |
| 1.1082 | 1.1075 | 0.06% | (0, 3) (1, 7) (1, 7), 0 |
| 1.7052 | 1.7029 | 0.13% | (1, 5) (1, 4) (1, 4), |

For the above-mentioned RGB calculation, we can use the addition of the present invention to accomplish color space conversion.

### Example 3

### Division Calculation

If we use the multiplier (10) provided by the present invention to make division calculation, we can only get an approximate quotient and can't get the remainder. But this is enough for some applications. Suppose the input signals are to be divided by 3, 5 and 7 separately. These calculations are equivalent to multiplication by 0.3333, 0.2000 and 0.1429. Therefore, a four-grade multiplier (10) can be used. The maximum rightward shifting of shifter adders (20) is 8, and a table can be established to find the optimal coefficients (see table 7 below).

TABLE 7

| True value | Approximate value | Error | Coefficient |
|---|---|---|---|
| 0.3333 | 0.3333 | 0.15 | ×10⁻⁴ (0, 8) (0, 4) (0, 2), 2 |
| 0.2000 | 0.2000 | 0.15 | ×10⁻⁴ (0, 8) (0, 4) (0, 1), 3 |
| 0.1429 | 0.1428 | 1.84 | ×10⁻⁴ (0, 7) (0, 7) (0, 3), 3 |

From the above description, it can be understood that the multiplier provided by the present invention is an n-grade multiplier composed of several shifter-adders and one shifting carrier in series connection, and it can get relatively accurate products according to different application occasions. Moreover, it can simplify the number of logic gates and provide a high precision in actual integrated circuit (IC) design, and provide an effective solution for the shortcomings of traditional multipliers for non-integral multiplicators. Therefore, the present invention meets requirements of creation patents. Please approve the present invention to be a legal patent, so as to benefit the people and the country.

However, the techniques, drawings, programs or control and other methods described above are only examples of the present invention. So, any equivalent change or decoration or partial copy of the functions shall also be covered in the protected range of the claimed patent.

We claim:

1. A kind of multiplier for non-integral multiplicators, comprising
A coefficient table of the optimal approximate values obtained according to different multiplicator values;
n−1 adder-subtractors in cascade, which performs addition, subtraction and shifting according to the coefficient values in the coefficient table to get an approximate value, and transmits the approximate value to the adder-subtractor of the next grade;
A carrier who deals with carries produced in calculation, and
A n-grade multiplier, which is composed of the above, and performs multiplication of non-integral values.

2. The multiplier for non-integral multiplicators as claimed in claim 1, wherein the coefficient table includes shifting coefficients, coefficient for selection of addition or subtraction and bypass parameter. Among the coefficients,
The displacement coefficient is the bits standard for rightward shifting after the adder-subtractor inputs the multiplicands, and
The selection parameter makes the adder-subtractor perform addition or subtraction.

3. The multiplier for non-integral multiplicators as claimed in claim 1, wherein the parameter combination of the optimal approximate values corresponding to each individual multiplicator is stored in ROM, and when a specified multiplicator is required, the corresponding parameter combination will be got from the table stored in ROM.

4. The multiplier for non-integral multiplicators as claimed in claim 1, wherein the grades number (n) is 4˜5 preferentially.

5. The multiplier for non-integral multiplicators as claimed in claim 1, wherein the shifting parameter is under 12.

6. The multiplier for non-integral multiplicators as claimed in claim 1, wherein the parameter input of the displacement carrier at each grade is arranged properly by time sequence so as to form a pipeline structure.

7. The multiplier for non-integral multiplicators as claimed in claim 1, wherein the number of displacement adders can be increased or reduced according to the design requirements so as to reach the balance between the precision and the number of logic gates.
